(19) United States
(12) Patent Application Publication
(10) Pub. No.: US 2016/0328986 A1
(43) Pub. Date: Nov. 10, 2016

(54) SYSTEMS, METHODS AND DEVICES FOR CALL CENTER SIMULATION

(71) Applicants: Ruth Antonnette Corpus, Glenwood (AU); Yuansheng Fan, Shanghai (CN); Jun Zhou, San Marino, CA (US)

(72) Inventors: Ruth Antonnette Corpus, Glenwood (AU); Yuansheng Fan, Shanghai (CN); Jun Zhou, San Marino, CA (US)

(21) Appl. No.: 15/147,636

(22) Filed: May 5, 2016

Related U.S. Application Data
(60) Provisional application No. 62/157,850, filed on May 6, 2015.

(51) Int. Cl. G09B 7/06; G09B 19/00; G09B 5/06; G06F 3/16

(52) U.S. Cl. CPC G09B 7/06; G06F 3/165; G09B 19/00; G09B 5/06

(57) ABSTRACT

Simulation of an incoming call to a call center agent can be performed by supplying audio information, a simulated software interface and receiving responses based on the audio information. For example, an agent can log into a training system that includes a user interface (UI) that includes a training interface and a simulation interface. The agent can play pre-recorded audio that represents a customer interaction through use of the training interface. Based on the pre-recorded audio, the agent can interact with the simulation interface to act on the pre-recorded audio. The simulation interface can then grade the interaction of the agent.

### RELATED APPLICATION

This application claims the benefit under 35 U.S.C. §119(e) of U.S. Provisional Application No. 62/157,850 filed May 6, 2015, which is incorporated by reference herein in its entirety.

### TECHNICAL FIELD

The present disclosure relates to computer simulation and more specifically relates to simulation of call center interactions.

### BRIEF DESCRIPTION OF THE DRAWINGS

FIG. 1 is an example of a call center simulation user interface system consistent with embodiments disclosed herein.

FIG. 2 is an example of a simulation select interface consistent with embodiments disclosed herein.

FIG. 3 is an example of a grading page consistent with embodiments disclosed herein.

FIG. 4 is an example of an incoming call interface consistent with embodiments disclosed herein.

FIG. 5 is an example of a simulation replay interface consistent with embodiments disclosed herein.

FIG. 6 is an example of a script editing interface consistent with embodiments disclosed herein.

FIG. 7 is an example of a simulation design interface consistent with embodiments disclosed herein.

FIG. 8 is a block diagram of a call center simulation system consistent with embodiments disclosed herein.

FIG. 9 is a flow chart illustrating a method for simulating a call center consistent with embodiments disclosed herein.

FIG. 10 is a schematic diagram of a computing system consistent with embodiments disclosed herein.

FIG. 11 is an example of a training history user interface consistent with embodiments disclosed herein.

FIG. 12 is an example of a quiz question user interface consistent with embodiments disclosed herein.

FIG. 13 is an example of a quiz question creation user interface consistent with embodiments disclosed herein.

FIG. 14 is an example of a report interface consistent with embodiments disclosed herein.

FIG. 15 is an example of a scenario report interface consistent with embodiments disclosed herein.

FIG. 16 is an example of a coaching report interface consistent with embodiments disclosed herein.

FIG. 17 is an example of a readiness report interface consistent with embodiments disclosed herein.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Techniques, apparatus and methods are disclosed that enable simulation of an incoming call to a call center agent by supplying audio information and receiving responses based on the audio information. For example, an agent can log into a training system that includes a user interface (UI) that includes a training interface and a simulation interface. The agent can play pre-recorded audio that represents a customer interaction through use of the training interface. Based on the pre-recorded audio, the agent can interact with the simulation interface to act on the pre-recorded audio. The simulation interface can then grade the interaction of the agent.

The simulation interface can simulate a client system without access to the client system. This can allow for separation of live data from simulated data, so that a production system does not need to contain dummy information. This also allows for simulated use of sensitive data, such as social security numbers and credit card information. Whereas a production system may reject simulated sensitive data (such as being unable to process a simulated credit card number), the simulation interface can be configured to accept simulated sensitive data. This can allow for easier training without issues of incorrect handling of protected information (HIPAA, PCI, etc.).

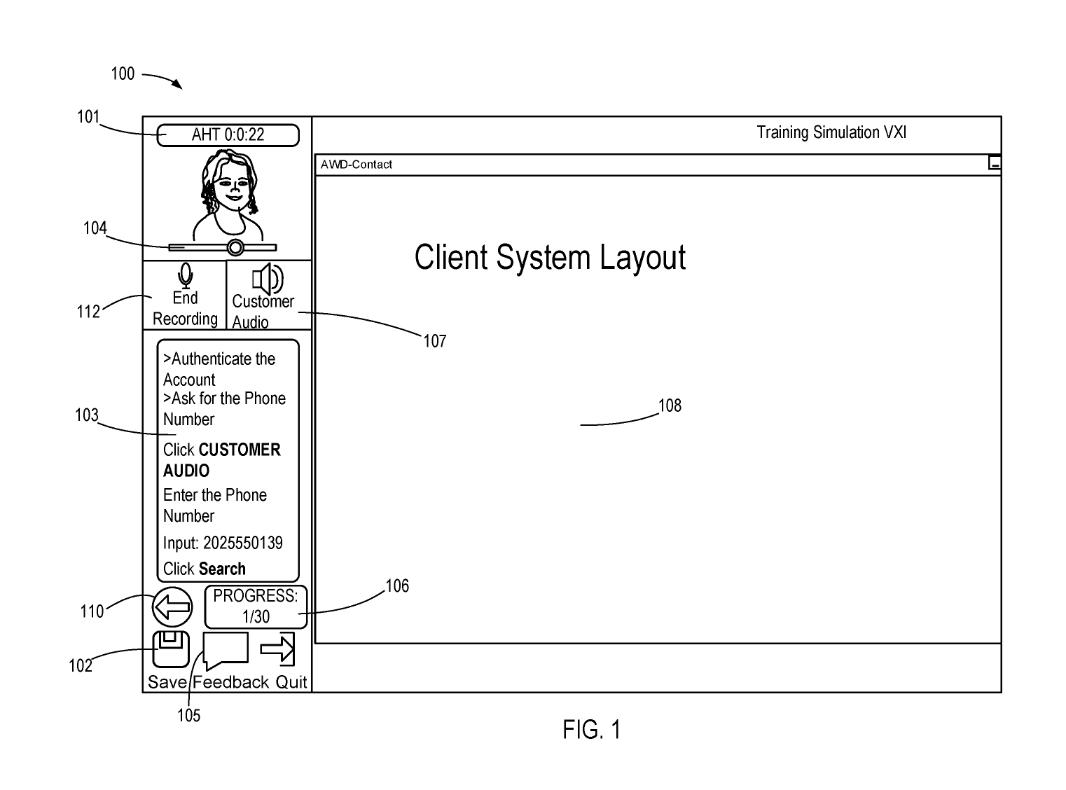

An embodiment of a user interface 100 is shown in FIG. 1. The user interface 100 includes a timer 101, a save button 102, assistance information 103, a volume adjustor 104, a simulation feedback button 105, a progress indicator 106, a response recording button 112, a simulation screen 108, a customer audio button 107, a back button 110 and a reporting tool (not shown).

The timer 101, or average handling time (AHT) count, provides an indication of time, such as time elapsed since the call simulation began. The save button 102 can be used to save and/or resume the simulation.

The assistance information 103 can include different levels of assistance during the simulation. For example, a level 1 assistance can include detailed information of how to progress through the simulation (also known as fully assisted simulation). A level 2 assistance (also known as an assistance on-demand simulation) can use the assistance information 103 to provide information when an agent is stuck (e.g., requests help, exceeds a timing threshold for an operation, etc.). In a level 3 simulation, the assistance information 103 can be left blank or removed (also known as a solo simulation).

The volume adjustor 104 can be used to adjust simulated call volume. The simulated call audio can be activated by a customer audio button 107. The simulation feedback button 105 can be activated by an agent to provide feedback to simulation creators to improve the simulation and/or identify problems with the simulation. The progress indicator 106 can show a current position in a simulation, such as a percentage complete or number of operations remaining, number of operations completed, etc. In some embodiments, an agent can use the back button 110 to review a prior operation. The response recording button 112 can be activated to cause a recording of an agent vocal response to a simulation operation (such as simulated customer audio activated by customer audio button 107). The simulation screen 108 can be used to present a simulated customer system interface (e.g., a simulation of call center software, simulation of troubleshooting software, etc.). A simulation screen 108 can allow replication of environments that may not be available in a training environment using live software. For example, an end-to-end sales process can be simulated that includes simulated credit card and simulated social security number information that would be rejected by live software. The reporting tool (not shown) can collect simulation information and present results, statistics, compiled information, etc., of one or more simulation sessions. The reporting tool can track various performance groups, including a single agent, a trainer, a class of agents, etc.

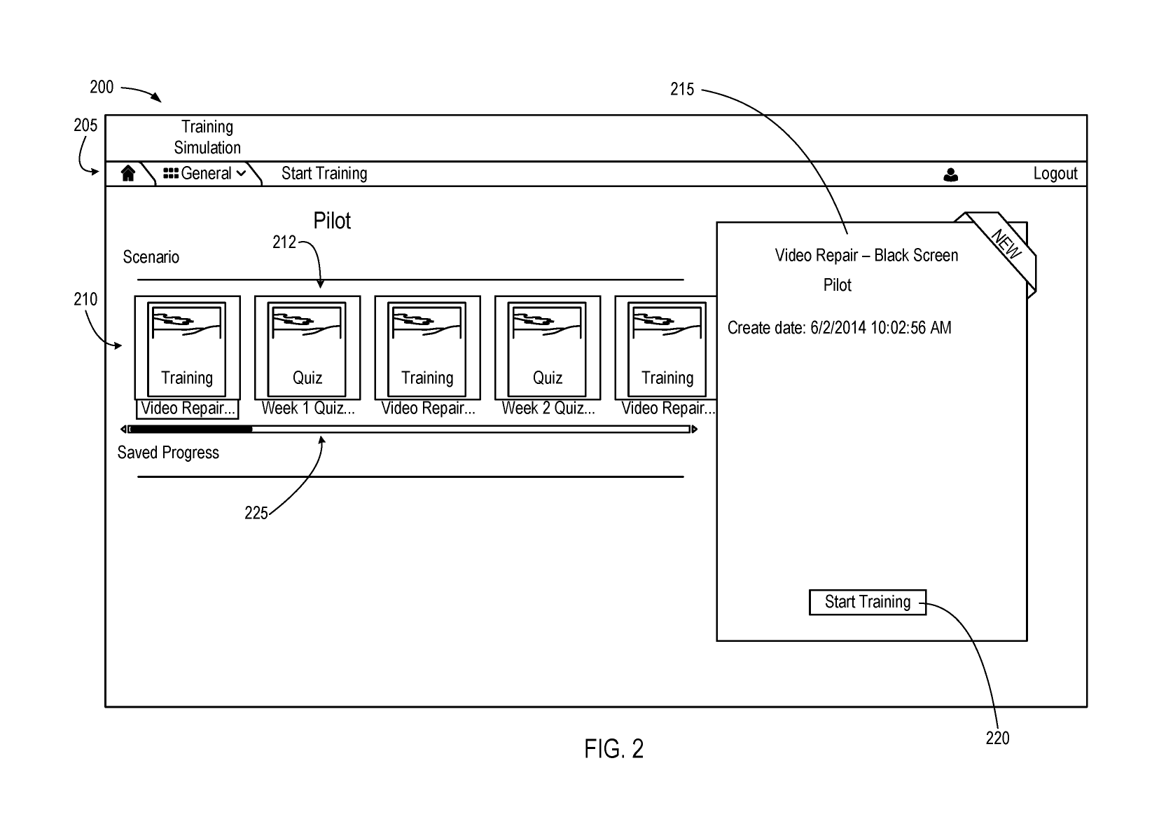

In some embodiments, the training system can include multiple scenarios that each simulate resolving a customer issue through a phone call with a customer. An example of a simulation select interface 200 is shown in FIG. 2. Scenarios 210 can be selected from a set of scenarios. When a scenario 210 is selected, progress 225 and a description 215 can be shown. A start training button 220 can be used to start the selected scenario 210. A menu 205 can be used to select different screens (or interfaces).

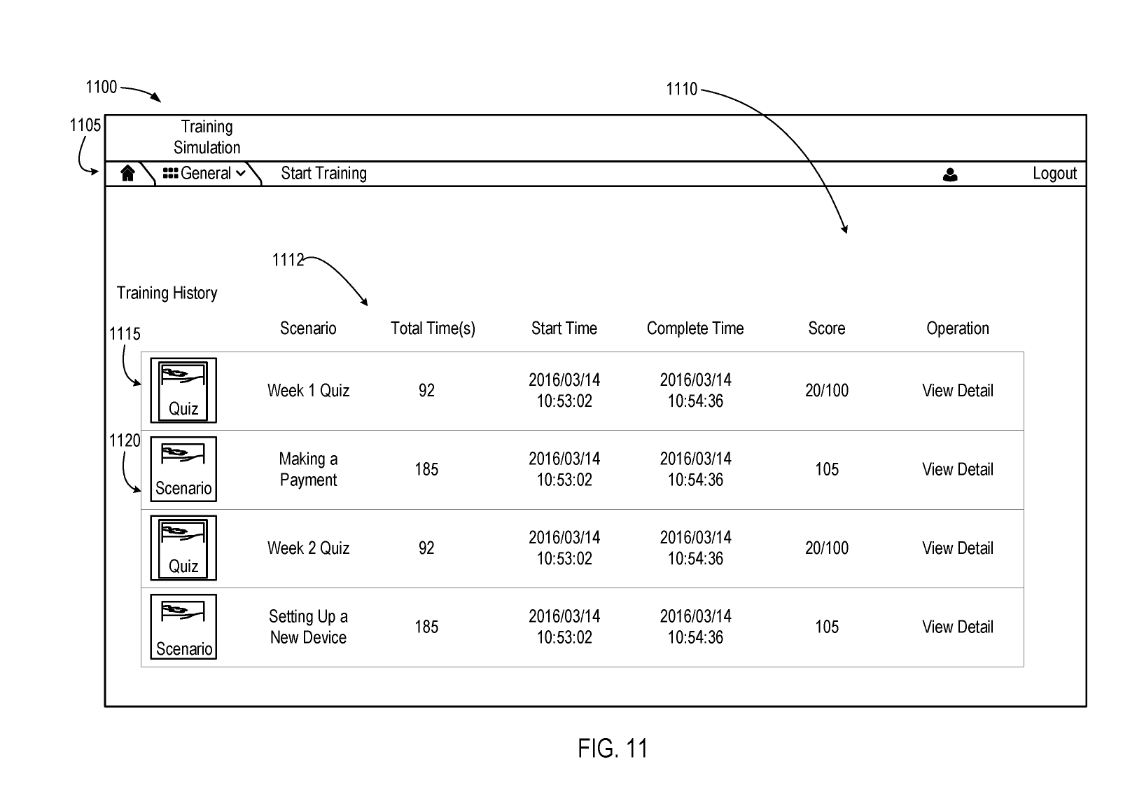

In addition to scenarios 210, quizzes 212 can also be provided. A quiz 212 can be a series of questions that review knowledge of aspects of the training. For example, a quiz 212 can include questions about drug policy, training review, system inputs and/or other policies or training review items. Quizzes 212 are further discussed in reference to FIGS. 11-14.

Each scenario 210 can be broken down into steps and/or operations. The steps can be associated with actions performed in the simulation interface. A subset of the steps can be associated with audio information in the training interface. For example, an agent may need to search for a customer in the simulation interface. The agent can click on a play button in the training interface that causes an audio file to play. The audio file can include a pre-recorded voice that provides address information. The agent can enter this information into address fields in the simulation interface, which is a first step. The agent can then click on a record response button to record a vocal response to the pre-recorded voice. The agent can then click on a search button, which is a second step. The simulation interface can change to show a list of potential customer matches. The agent can then click on a customer name, which is a third step. The agent can then click on a load customer button, which is a fourth step. The simulation interface can then change to show customer information. The training interface can then load a new audio file to play for the agent.

The training system can also vary the amount of assistance given during the simulation. In one embodiment, there are three levels of scenarios in the training simulation tool. A first level can be labeled “fully assisted.” In the “fully assisted” level, the training system provides full assistance to an agent. The instructions can be customized to be as detailed as needed. In some embodiments, bullet points are used to guide the agent. In other embodiments, a suggested scripting is placed in the instruction field.

A second level of assistance for a scenario can be labeled as “assistance on-demand.” In this second level, no instructions are initially given in the instruction field. However, an agent can click the help button and instructions will be made available. When and at which step an agent clicked the help button can be measured (also known as a help by demand button). The pressing of the help button can be an indicator for trainers that there is a knowledge gap.

A third level of assistance can be labeled as “flying solo.” At the third level, no instructions are available. An agent will have to handle a call as if the call were really to a customer. No assistance is available. If the agent makes a mistake, the system can record that error for grading.

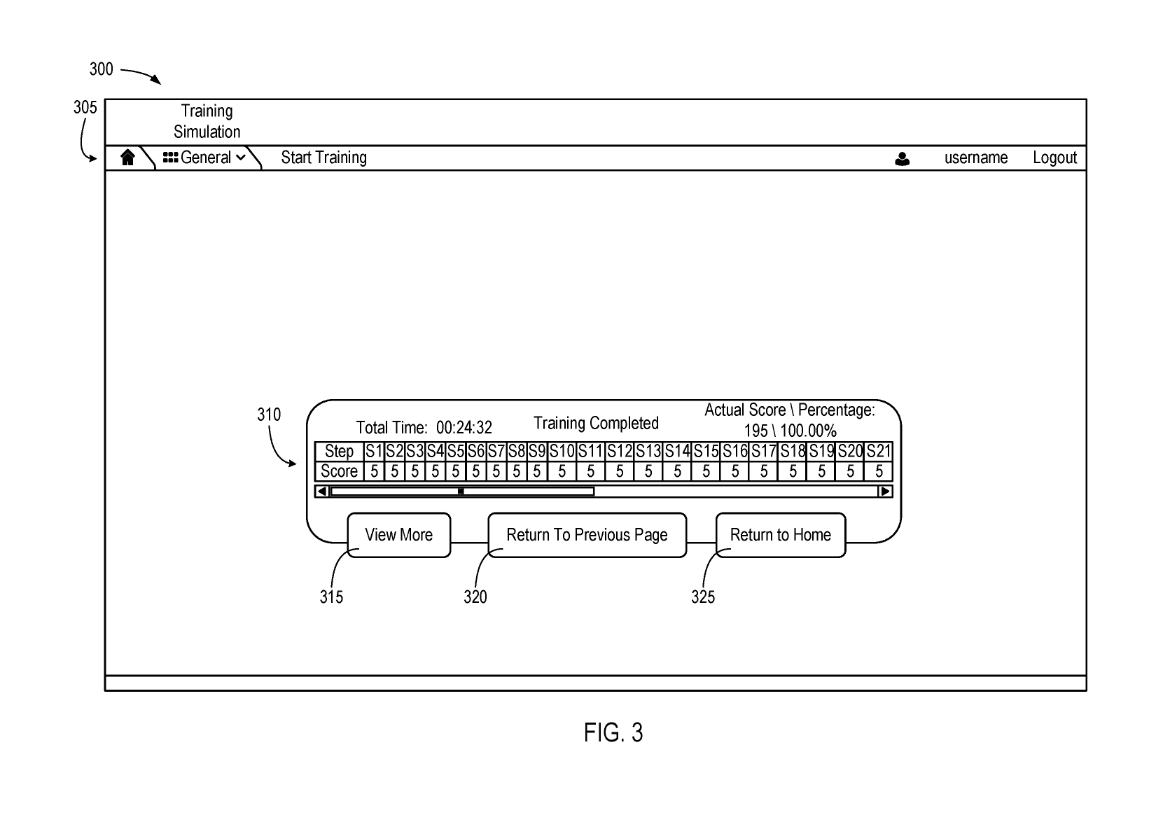

Each step of a scenario can be graded. The steps can be graded on accuracy, attempts, duration, etc. In one embodiment, an agent is provided a limited number of attempts to complete the step before the system moves on. An example grading page for a 21-step scenario is shown in FIG. 3.

In FIG. 3, an agent has been scored for a 21-step process, and a scorecard 310 is shown on a scorecard screen 300. In one embodiment, an agent can review the scorecard 310 after completing (or failing, quitting, etc.) a scenario. The agent can be presented with options such as a menu 305, a view more button 315, a return to previous page button 320 and/or a return to home button 325. The view more button 315 can cause the system to present more detailed information about the scorecard 310 (such as operations that were correctly or incorrectly completed, reasoning for the scoring, etc.). The return to previous page button 320 can cause the system to go back to a previous page (such as a scenario select screen). The return home button 325 can cause the system to present a main menu screen or home screen.

The scorecard screen 300 shows that the agent has received a score of all 5s, with a call time of 24 minutes and 32 seconds, and a score of 195, which is 100% correct. Scoring can be calculated in multiple ways. In a subtractive embodiment, an incorrect answer subtracts one point from a five-point total. An answer can be based on keywords (such as free-form text describing a problem), exact matching (such as address information), selection (such as checkboxes or radio buttons) or other criteria. In some embodiments, if a score for a step is zero, the agent can be allowed to proceed to a next step. In some embodiments, a recorded voice response from an agent is translated to text and analyzed (e.g., for keywords, inflection, emotional response, etc.). In one embodiment, a score can be highlighted if a mistake was made. In some embodiments, scores can be customized, such as using different point values (e.g., a score of 10 or 100 can be used, a score does not need to be 5). In an embodiment, a trainer can set up scores per try and select a value.

The training system can use various measurements. In one embodiment, an average handling time (AHT) is used. The training system can measure AHT for each step and an overall AHT for the call. In an embodiment, an AHT is compared with an expected or average AHT threshold for a step or call. Steps that exceed the AHT threshold can be marked. In another embodiment, typing accuracy and/or speed can be measured. Depending on the embodiment, the measurements can be scored and/or form part of a composite score.

In some embodiments, an agent's awareness can be scored. In one embodiment, an agent can be scored on emotional change identification. For example, if a vocal tone or speaking pace of the simulated customer audio information changes, an agent can click on an emotional identification icon to inform the training system of a change of emotional state. In another embodiment, an agent can be scored on identifying opportunities. For example, if the audio information includes a statement that the simulated customer has just purchased a home, the agent can click an upsell button to notify the training system that a potential upsell opportunity has been identified.

In some embodiments, scoring can be used to build a quality assurance (QA) form that would be similar to a QA form given to an agent handling live calls. In one embodiment, a trainer is provided with the scoring and agent audio responses. The trainer can fill out a web form that creates a QA form based on the answers given by the agent and/or the training system.

A reporting system can also be used to provide reports on agent simulations. In one embodiment, critical steps are identified as part of a scenario. Failures in the critical steps can be identified in the report to help with further training of an agent. In an embodiment, a critical step is identified as a step that has influence over a key performance indicator (KPI). For example, an agent who fails to capture address information correctly while booking a technician to visit the customer's site would fail a critical step. The wrong address will impact the customer's experience because the technician will not arrive at the correct house. In some embodiments, the reporting system can be configured to share reports with other users (such as other managers or leadership). For example, the reporting system can be configured to share the latest reports with a specified set of users, email addresses or other accounts.

In one example, an agent accesses a training simulation server through a URL. The agent then provides a user ID and password, which can be limited to use by one agent at a time. The agent can access training modules through a menu, such as a “General” menu, followed by selection of a “Start Training” menu item.

The agent can then find scenarios she/he has permission to access. In some embodiments, the scenarios can be configured for the agent specifically (e.g., level of help, timing thresholds, other thresholds, etc.). An example of scenario selection can be seen in FIG. 2. The agent can select a scenario and then click a start training button.

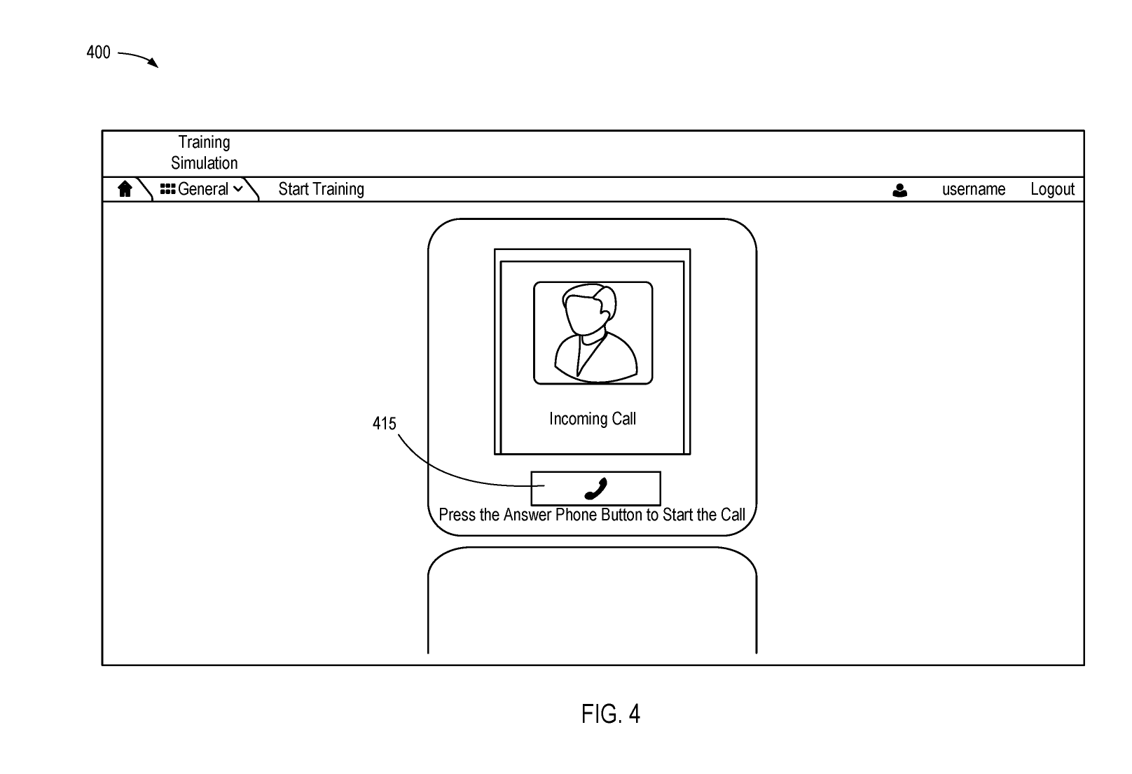

After starting the training, the agent can then be presented with an incoming call interface 400 as shown in FIG. 4. The agent can click on an answer button 415.

The agent can then view a call center simulation user interface that includes a training interface and a simulation interface (or navigation pane) as seen in FIG. 1. The agent can then click on a start recording button and provide an opening statement to a simulated customer. The agent can then click on a customer audio button and listen to a pre-recorded statement from the simulated customer. The audio volume can be adjusted with the volume adjuster. A progress bar shows a current step number in the simulation. In the embodiment shown, the scenario has 30 steps and this screen represents the first step. Based on the audio information, the agent fills out information in the simulation interface. Depending on the embodiment and/or scenario, the agent can advance to a next step through interaction with the simulation interface or the training interface (e.g., through a next button, etc.). If needed, the agent can review an instruction sidebar or bar to determine what is needed to advance to a next step. The agent can then interact with the training interface to receive simulated customer audio, receive instructions and/or provide a recorded response. If needed, the training interface provides a button to save the progress of the scenario for later (which can be resumed by selecting the scenario again from the scenario selection screen). After completing a scenario, the agent can review his/her answers given.

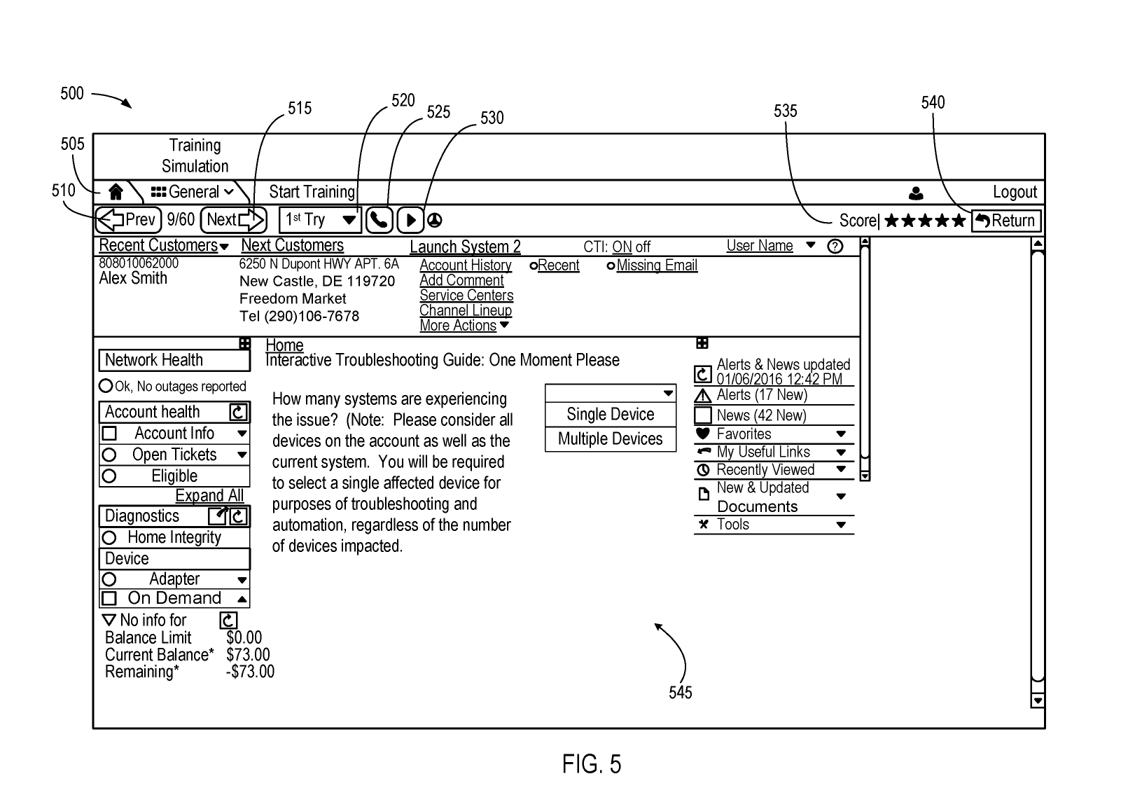

In the embodiment shown in FIG. 5, an example of a simulation replay interface 500 is shown. An agent can review his/her responses to a simulated customer and perform one or more operations. The interface 500 can include a previous step button 510, a next step button 515, a tries icon 520 or selector, a simulated customer audio play button 525, a recorded agent response play button 530, an operation scoring display 535 (shows five stars), a return button 540 (to return to a simulation or user select screen, etc.) and a simulation display area 545.

The previous step button 510 and the next step button 515 allow movement between steps. The tries icon 520 indicates the number of tries taken to complete the step. The simulated customer audio play button 525 (telephone icon) causes the system to play a simulated customer's audio for the step. The recorded agent response play button 530 (arrow icon) causes the system to play an agent's recorded voice. The return button 540 causes the system to return to a simulation or user select screen, etc. The simulation display area 545 (or navigation pane) displays agent navigation input for the step. In the embodiment shown, the score is represented by stars where each star is equivalent to one point, with a maximum of five points per step.

The training simulator can also provide reporting for trainers of the agents. In addition to individual scoring, as described above, aggregated scoring of a class can be provided to trainers. Data can include average time per scenario, total time per scenario, version of the scenario, class identification, help level, username, score, percentage, steps failed, retry count, feedback, total score, steps that used help, percentage of steps that used help and/or date information (e.g., date opened, date accessed, date finished, etc.). Various filters can be used to drill down to specific information, including project, scenario, version, class, level, dates, etc. The reports can be exported to file formats for viewing and/or analysis (e.g., Excel, Access, etc.).

Reports can also be used to drill down to specific scenario instances. For example, a report can highlight errors in a scenario. The report can be organized by number of steps failed. The trainer can click on an agent's username and be taken to a report highlighting that agent's performance on the scenario. The report can include an ability to listen to recordings and/or change scoring that was inaccurate.

An administrative interface can aid in the preparation of scenarios and quizzes in the training simulator. In some embodiments, an administrator can create a scenario by composing a script of the scenario, applying the script to a template, creating a simulation design and applying the template to the design.

In one embodiment, a script includes steps, agent input, customer input, audio files, screenshots and instructions. Script data can then be used to create a template, which describes parameters of a simulation, including time allowed for each step, number of retries allowed, points for successful completion, error messages, etc. The template can be uploaded to a scenario design application. The scenario design application combines the data from the template and linked files into a scenario. A scenario can be a set of screens through which an agent can progress (and/or upon which agent responses can be graded). The scenario design application allows an administrator to provide input methods, assign correct answers, assign actions to move to a next step, provide error messages, provide instructions, format instructions, require a recorded response from an agent and/or provide other simulation configuration. When design is complete, the administrator can enable the scenario for use by agents.

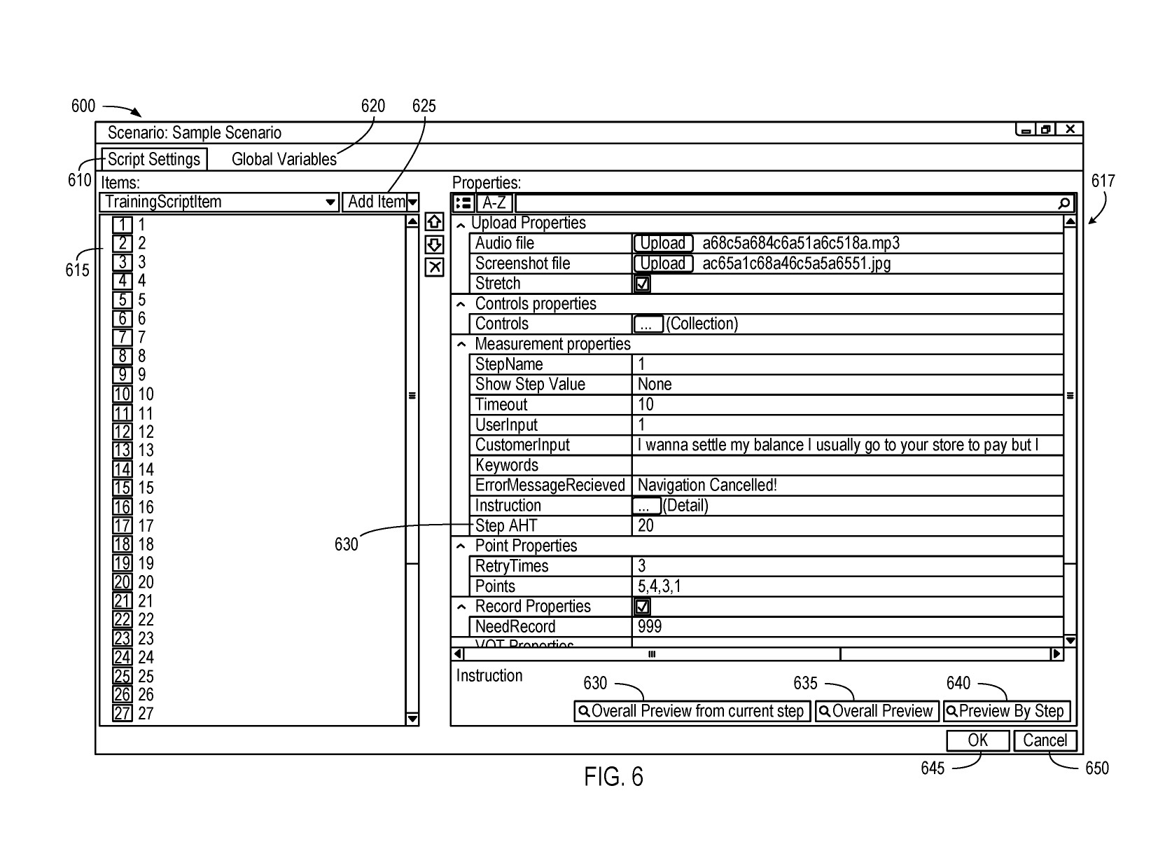

In one embodiment, shown in FIG. 6, a script editing interface 600 of a scenario design application is shown. The script editing interface 600 allows editing of script data that includes script steps 615 and script step parameters 617 (such as agent input, customer input, audio files, screenshots, instructions, etc.). The script editing interface 600 can include a settings tab 610, a global variables tab 620, a script add item button 625, script preview buttons 630, 635, 640, a script item list 615, a confirmation button 645 and a cancel button 650.

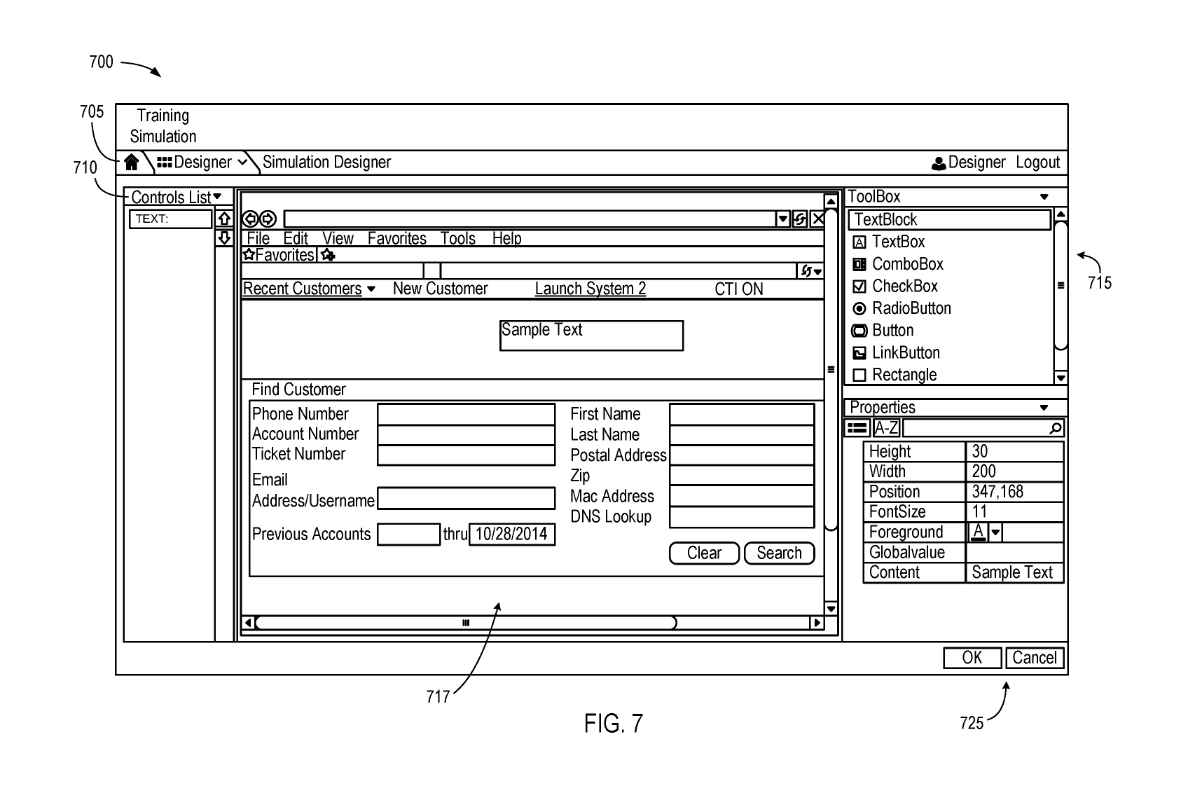

As shown in FIG. 7, a simulation design interface 700 of the scenario design application enables an administrator to provide input methods 715 on screenshots 717 for each step. The input methods 715 can include text blocks, text boxes, drop-down boxes, checkboxes, radio buttons, buttons, links, clickable areas and/or keyboard inputs. Properties of the input methods 715 can be altered, including height, width, position, font, size, content, etc. The input methods 715 can also be configured to determine correct or incorrect inputs. A list of the input methods 715 (or controls) can be in a controls list 710. A menu 705 can allow navigation within the application. When a design is complete, the administrator can cancel or accept the design through OK and/or cancel buttons 725.

In some embodiments, the simulation design interface can include an AHT forecast value. The AHT forecast can be used to predict handling time per step, handling time per group of steps and/or a total handling time. In some embodiments, the AHT value can be used to provide an indicator to an agent as to whether their handling time is close to the AHT for their phase or step.

Correct answers can be provided for use with the input methods, allowing for scoring and detection of incorrect inputs for a step. Answer detection can be set up to detect correct or incorrect agent input, including actions (such as clicking or selecting), exact text matching and/or keyword detection.

In some embodiments, an administrator may need to edit steps. This can occur due to client software changes, additional requirements or other changes to client operating procedures. With modular steps, as shown in FIG. 7, steps can be inserted, modified and/or deleted without affecting other steps. This allows changes to be made to parts of a scenario without doing a complete rewrite.

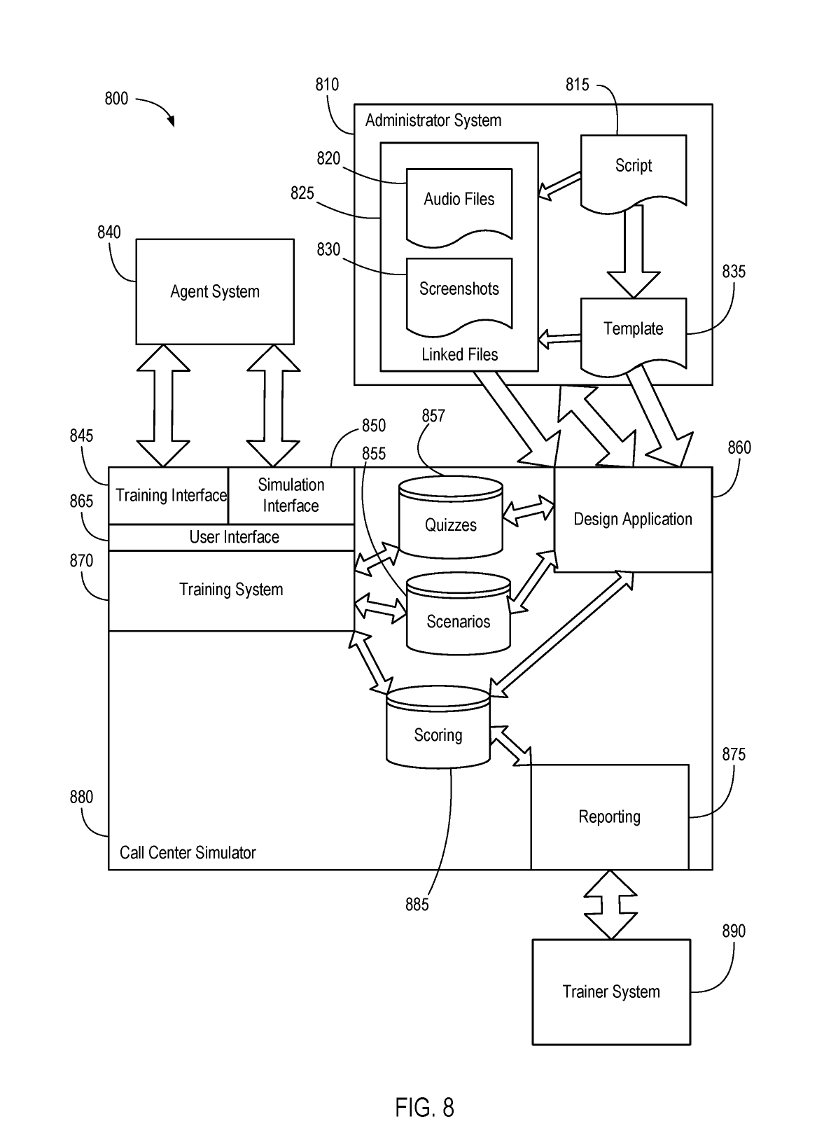

FIG. 8 is a block diagram of a call center simulation system 800. A call center simulator 880 can interact with an agent system 840, an administrator system 810 and a trainer system 890 as shown in FIG. 8. The agent system 840 can receive information from both a training interface 845 (e.g., instructions, customer audio, etc.) and a simulation interface 850 (such as screenshots, input methods, etc.) in simulating a scenario of a customer call to a call center. The agent system 840 can also send information to both the training interface 845 (e.g., a play audio request, recorded agent audio, etc.) and the simulation interface 850 (such as text input, clicks, etc.) of a training system 870 through a user interface 865. The trainer system 890 can receive scoring reports 875 about agents who have attempted scenarios 855, and interact with the call center simulator 880 to review responses, errors and recorded agent audio.

The administrator system 810 can create scenarios 855 and quizzes 857. The administrator system 810 can use a script 815 to create a template 835 with linked files 825 (e.g., audio files 820, screenshots 830, etc.). The template 835 and the linked files 825 can be transmitted to the call center simulator 880. Using a design application 860, an administrator can create scenarios 855 and quizzes 857 for use by the agent system 840 and scoring 885 for the scenarios 855 and quizzes 857.

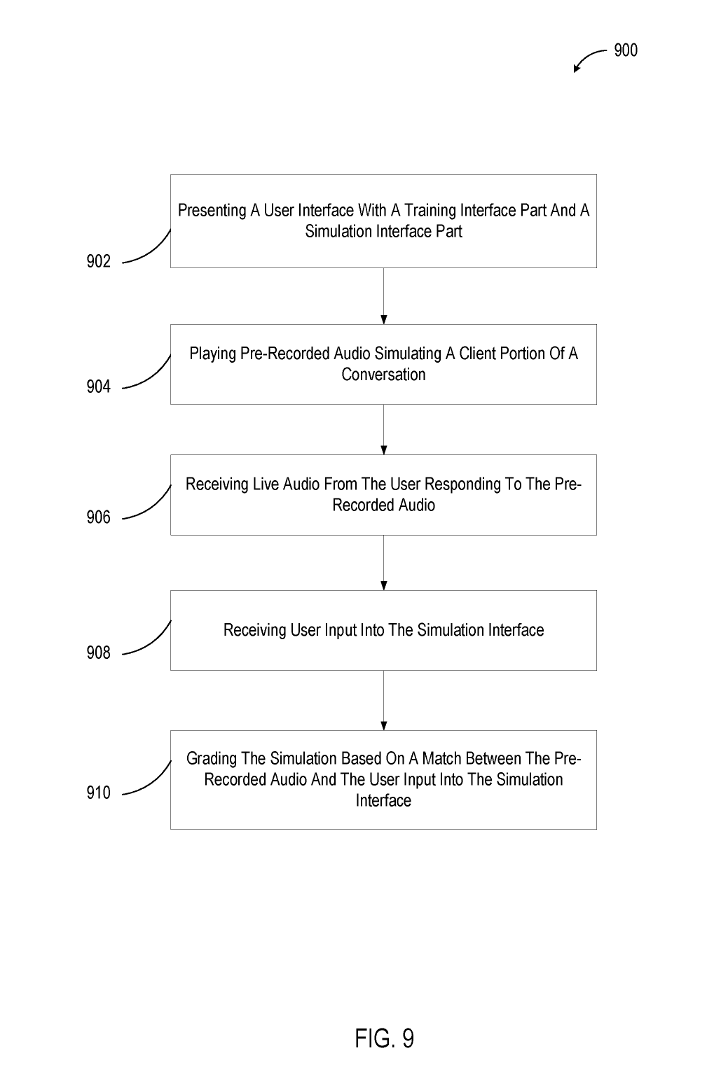

A method 900 of simulating a call center is shown in FIG. 9. The method 900 can be performed by systems, such as the systems shown in FIG. 8, including the call center simulator 880 and the administrator system 810. The systems present a user interface with a training interface part and a simulation interface part in block 902. In block 904, the system plays pre-recorded audio simulating a client portion of a conversation. In block 906, the system receives live audio from the agent responding to the pre-recorded audio. In block 908, the system receives agent input into the simulation interface. In block 910, the system grades the simulation based on a match between the pre-recorded audio and the agent input into the simulation interface.

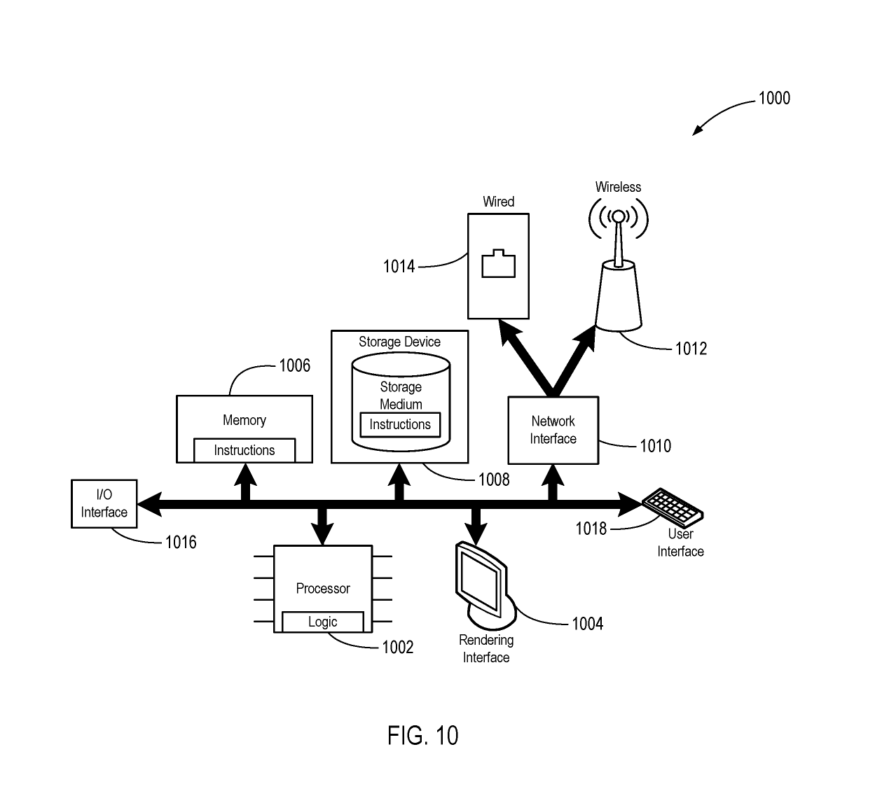

FIG. 10 is a schematic diagram of computing system 1000. The computing system 1000 can be viewed as an information passing bus that connects various components. In the embodiment shown, the computing system 1000 includes a processor having logic 1002 for processing instructions. Instructions can be stored in and/or retrieved from memory 1006 and a storage device 1008 that includes a computer-readable storage medium. Instructions and/or data can arrive from a network interface 1010 that can include wired 1014 or wireless 1012 capabilities. Instructions and/or data can also come from an I/O interface 1016 that can include such things as expansion cards, secondary buses (e.g., USB), devices, etc. A user can interact with the computing system 1000 through user interface devices 1018 and a rendering interface 1004 that allows the computer to receive and provide feedback to the user.

FIG. 11 shows an example of a training history user interface 1100. The training history user interface 1100 can include a menu 1105 for navigation, a history pane 1110, a quiz item 1115, a scenario item 1120 and summary columns 1112. The history pane 1110 provides information about training that has been accomplished and/or is in progress. The quiz item 1115 can provide a summary of a quiz that has been taken or is in progress. The quiz item 1115 can contain summary information that matches the summary columns 1112. In the embodiment shown, summary information includes quiz name, total time taken, start time, completion time, score and a link to a user interface to provide more information for the quiz item 1115. A quiz item 1115 can provide a summary of a quiz that has been taken or is in progress. The scenario item 1120 can contain summary information that matches the summary columns 1112. In the embodiment shown, summary information includes scenario name, total time taken, start time, completion time, score and a link to a user interface to provide more information for the scenario item 1120.

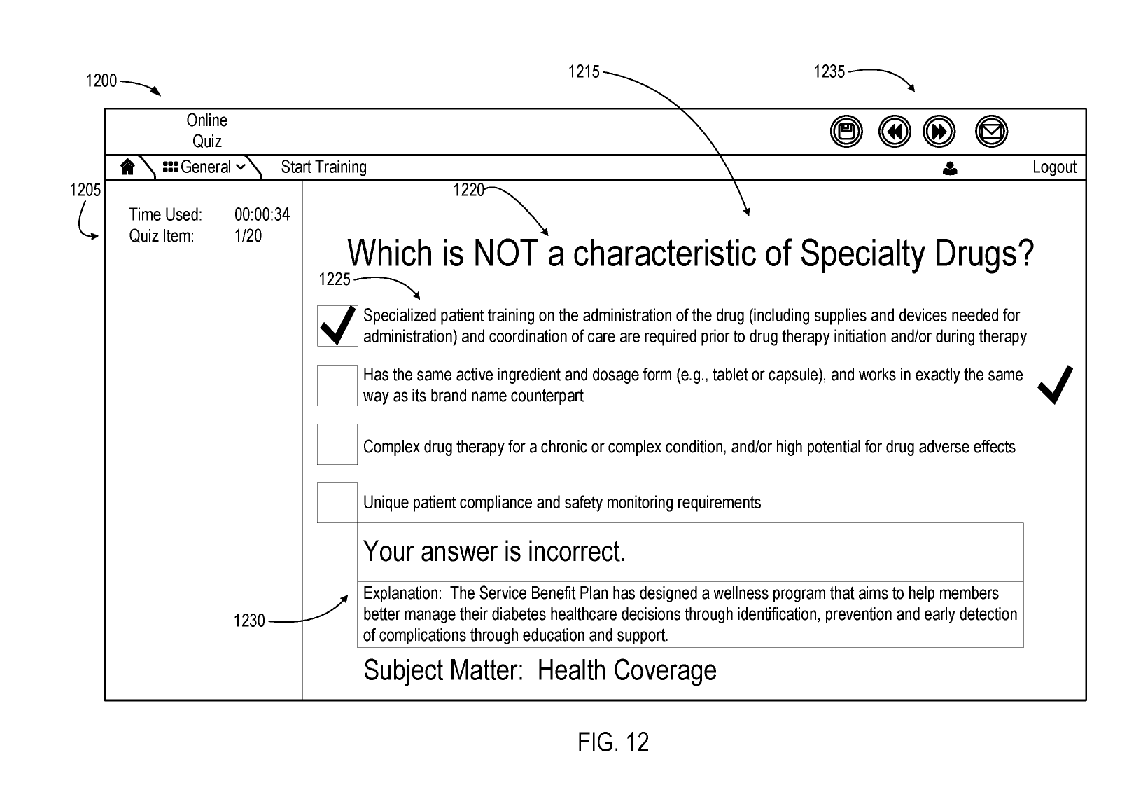

In FIG. 12, an example of a quiz question user interface 1200 is shown. The quiz question user interface 1200 can include a question interface 1215, a navigation interface 1235 and an information panel 1205 (sometimes referred to as an information frame). The question interface 1215 can include a description area 1220, an answer input 1225 and an explanation pane 1230. The answer input 1225 can receive answer information from an agent (such as through checkboxes, radio buttons, text boxes or other input means). In the embodiment shown, the answer input 1225 is from a multiple-choice answer. Once an answer is given, feedback about the answer can be given through the explanation pane 1230. The navigation interface 1235 can be used to navigate through a quiz (e.g., a set of questions, explanations, descriptions, etc.). The navigation interface 1235 can allow an agent to skip questions and/or come back to questions. In addition, the navigation interface 1235 can allow an agent to save the status of a quiz to come back to it later. In some embodiments, feedback about the quiz can be initiated through the navigation interface 1235. The information panel 1205 can provide overall quiz statistics and/or information. This can include time elapsed per question, time elapsed for the quiz, time remaining for the question, time remaining for the quiz, quiz items answered, quiz items remaining, total quiz items and/or current quiz item number.

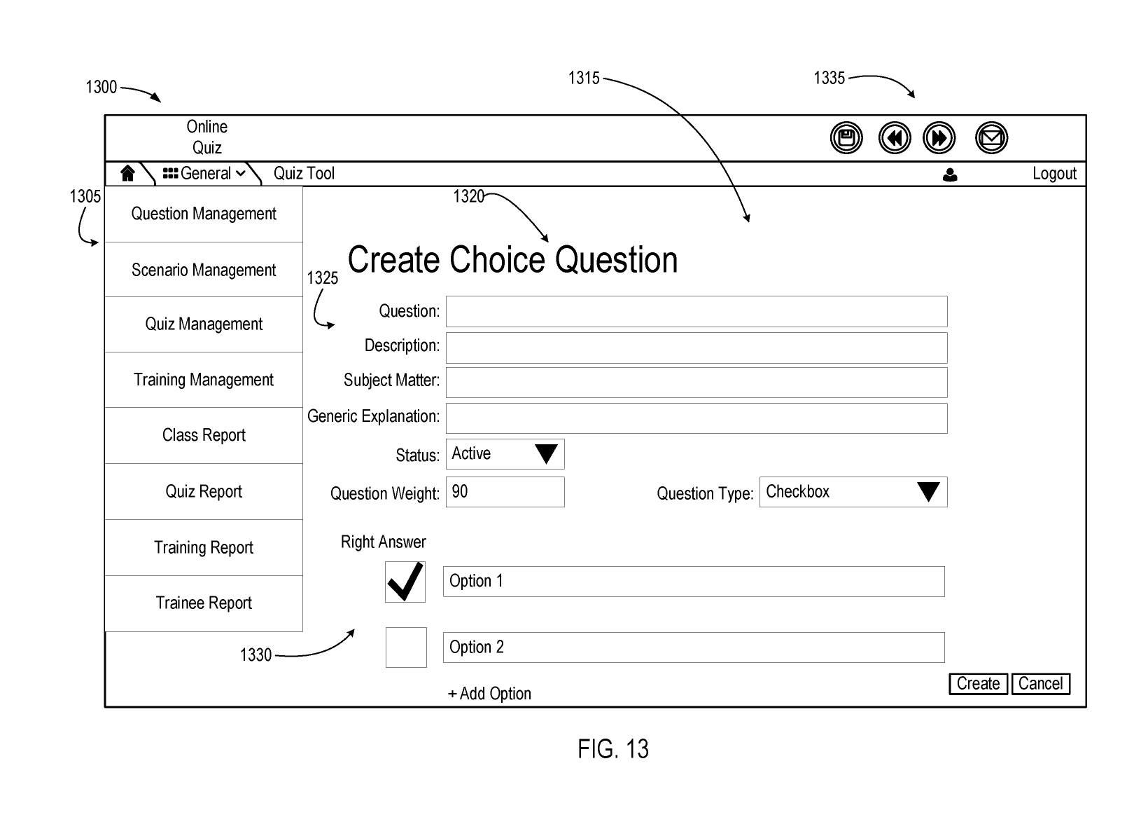

In FIG. 13, an example of a quiz question creation user interface 1300 is shown. The user interface 1300 can include a menu pane 1305, a creation pane 1315, a quiz creation interface 1320, a question creation section 1325, an answer creation section 1330 and a navigation interface 1335. The menu pane 1305 can provide options for navigating to other interfaces for creating quizzes, creating reports or preparing reports. For example, interface options can include quiz management functions including question management, scenario management, quiz management and/or training management. Interface options can also include report management functions including class reports, quiz repots, training reports and/or trainee reports. In some embodiments, a quiz interface and/or administrator interface can also be customized to better match client preferences.

The creation pane 1315 can be used to provide interfaces for creating, modifying and adjusting parameters of a quiz. For example, an interface can be the quiz creation interface 1320 with the question creation section 1325, the answer creation section 1330 and the navigation interface 1335. The question creation section 1325 can provide inputs for a question, including a question input, description input, subject matter input, explanation input, status selector, question weighting and/or question type selector. In some embodiments, questions can be assigned different weights. A question that bears a higher priority or importance in learning can have higher weighting towards an overall score for a quiz.

The answer creation section 1330 can provide inputs for creating answers for the question created in the question creation section 1325, such as multiple-choice answers (including single answer or multiple answer versions), free-form answers, completion-type answers or other answer types. In the embodiment shown, one or more input answers can be defined as a right answer. The navigation interface 1335 can be used to navigate between questions and save quizzes, questions and/or reports.

Depending on the embodiment, a quiz creator can attach different kinds of information, including videos, pictures, documents, audio, etc. These items can be employed for use with one or more questions. In some embodiments, each quiz can be categorized by different projects, divisions or teams. A quiz can be equipped with a timeout function for time-sensitive quizzes. In one embodiment, an option to display questions randomly per agent is also available.

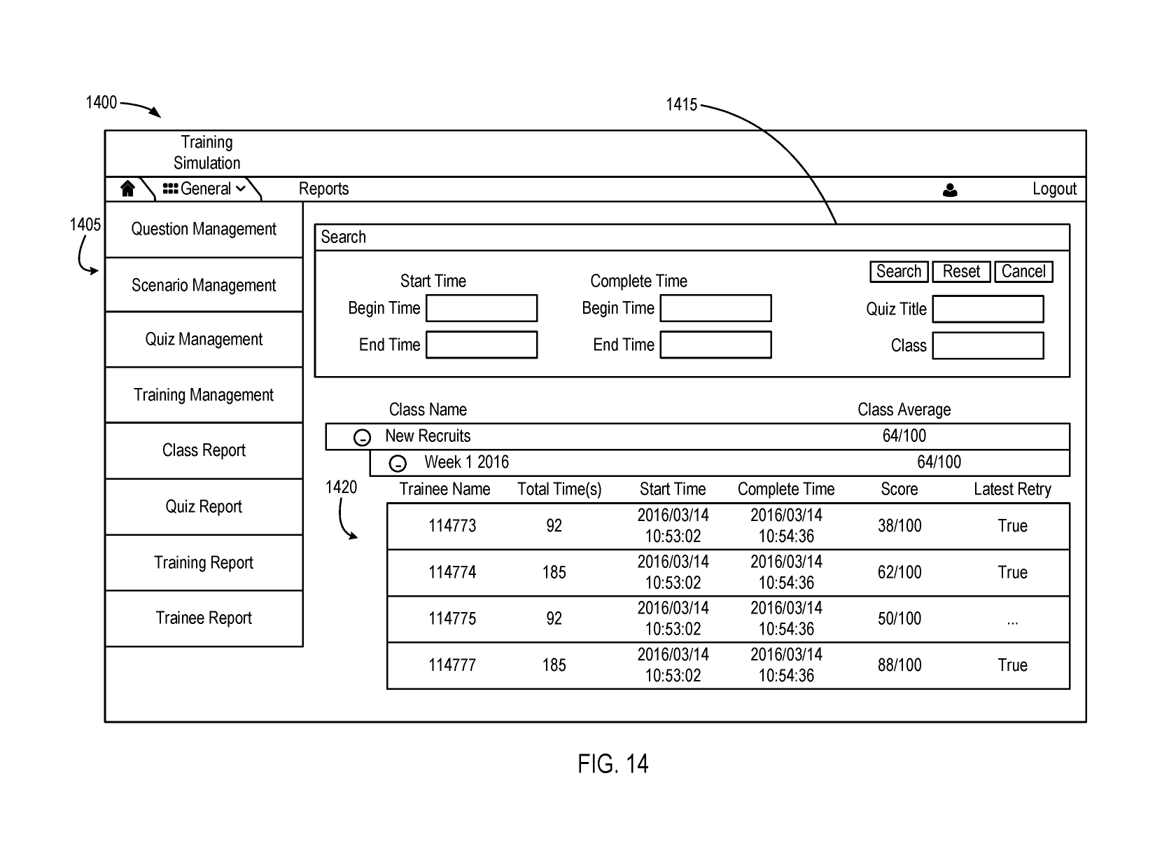

In FIG. 14, an example of a report interface 1400 is shown. The report interface can include a menu pane 1405, a search pane 1415 and a report pane 1420. The menu pane can be similarly operated as described in conjunction with the menu pane 1305 in FIG. 13. The search pane 1415 can allow an administrator or manager to create reports or find quiz statistics that match search parameters. Search parameters can include start times, completion times, quiz titles, class information, scores, number of retries, etc. The results of searches (or browsing) can be shown in the report pane 1420. Report items can be shown as rows, and columns can be customized to show specific statistics. In the embodiment shown, the statistics include trainee name, total time, start time, completion time, score and whether an item is the latest retry. In some embodiments, a statistic or report item can be clicked on to show additional details behind the statistic and/or report item. Additionally, the report pane 1420 can show sets and subsets. For example, the report items shown are part of the “new recruits” set and the “week 1 2016” subset. Statistics about the sets and subsets can also be shown.

Reports can also be restricted to authorized administrators and/or managers. For example, access restrictions can be implemented so that only authenticated users with permissions to access reports will be allowed to access reports. In other embodiments, access restrictions can be used to limit report information, only allow enumerated report types, anonymize report data and/or only allow aggregated report data.

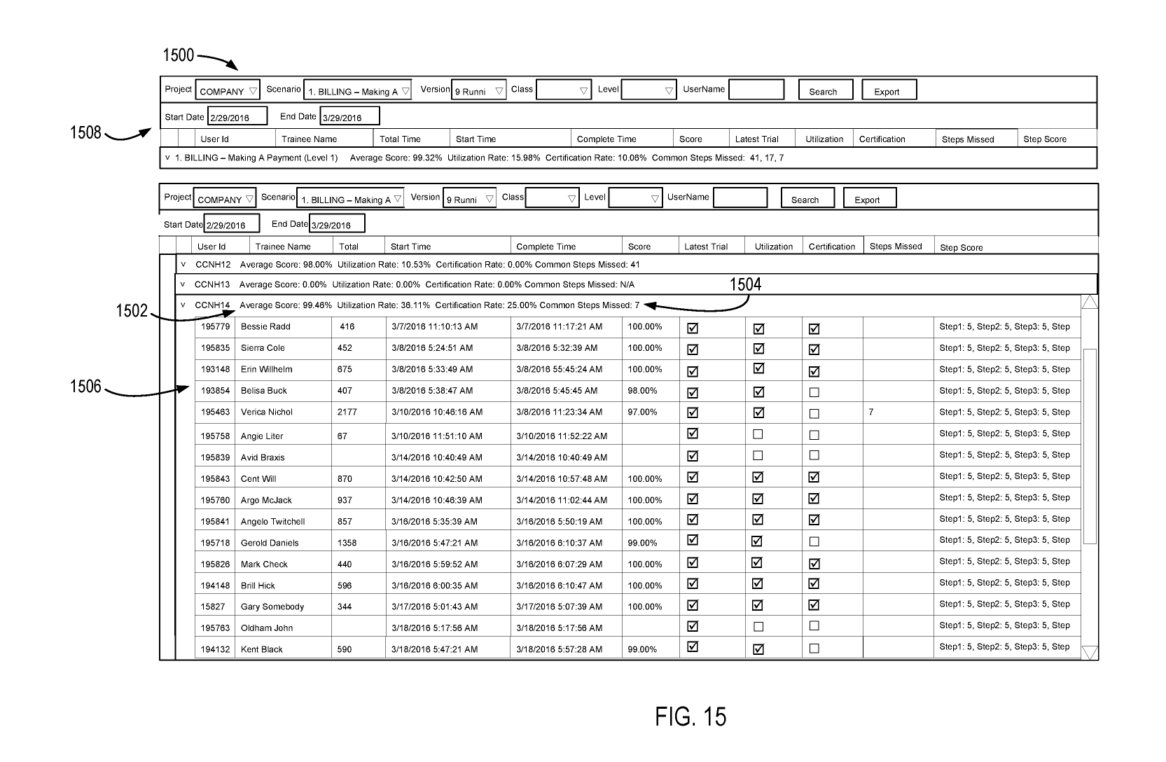

FIG. 15 is an example of a scenario report interface. A scenario report can display summary statistics 1502, class information (class CCNH14 in this example), individual statistics panel 1506 for a selected scenario (“1. Billing—Making A Payment” in this example) and navigation interface 1508. Navigation can be accomplished by clicking or selecting classes, scenarios or individual statistics. Individual summary information can include user id, trainee name, total score, start time, complete time, score percentage, indicator of passing a latest trial, indicator of meeting a utilization, indicator of certification of knowledge of the scenario, a list of steps missed and individual step scores.

A scenario report can display summary statistics 1502, including average scores, utilization rate and certification rate for a particular class of agents (CCNH14 in this example) or for an entire network of agents who took the scenario. The report can also summarize Common Steps Missed 1504. In one embodiment, a definition of “Common Steps Missed” can be customized based on business needs. For example, the report can be customized to count a missed step if first input is incorrect. The report can also be customized to count a missed step if the agent continues to miss the step after one or more retries. In the example shown, a missed step is counted as incorrect input after exhausting all retries.

In FIG. 15, scenario 1 has been selected in navigation interface 1508. A class CCNH14 has been selected. Summary statistics 1502 are shown next to the class name. The class statistics can include common steps missed 1504. Individual agent statistics for class CCNH14 are shown in individual statistics panel 1506.

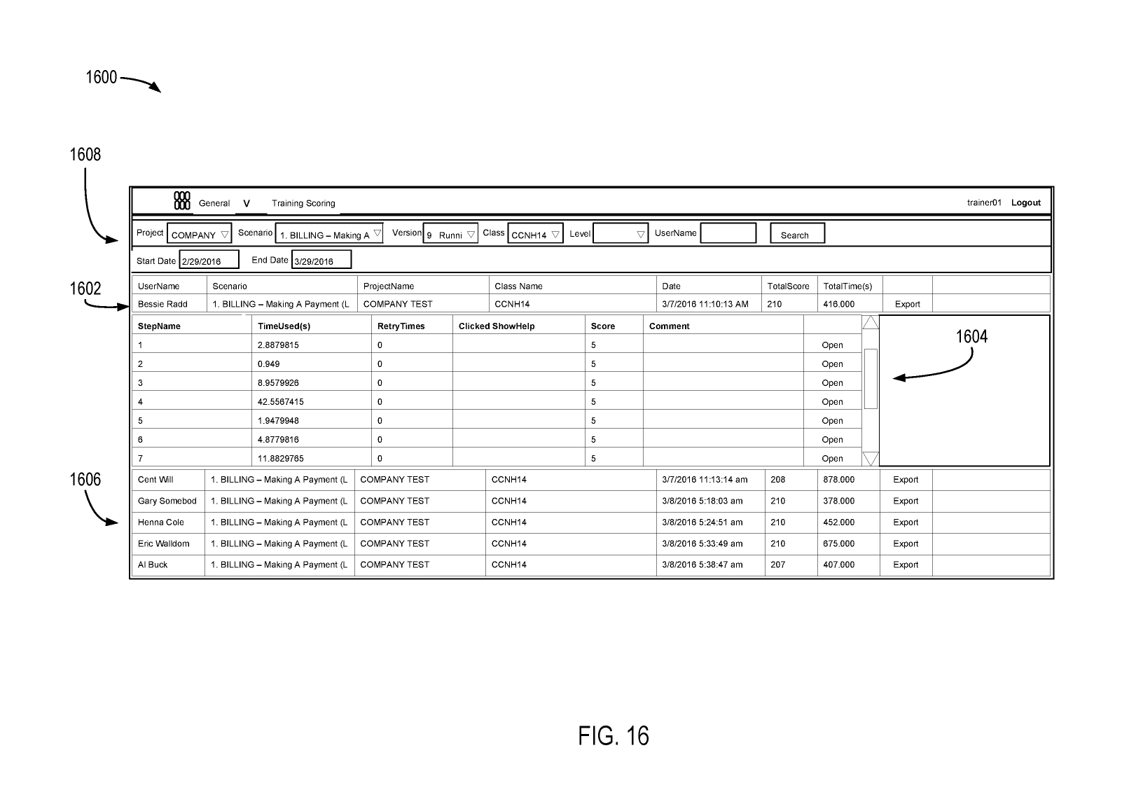

FIG. 16 is an example of a coaching report interface 1600. The report includes a navigation interface 1608, user identification panel 1602, step information panel 1604 and user listing panel 1606. When a user from user listing panel 1606 is selected, step information in step information panel 1604 for a scenario selected from the navigation interface 1608 is shown. Step information can include step name, time used per step, amount of retries, whether the user used a help interface, a step score and comments. The user identification panel 1602 can include username, scenario, project name, class name, date of the scenario taken, total score for the scenario, total elapsed time for the scenario and a button to export information (such as to a spreadsheet format, word processing format, list format or other data file).

The report 1600 allows a trainer to drill down to a specific step in the step information panel 1604 to address coaching gaps. It contains time taken to complete a step and navigation retries. In some embodiments, a trainer can playback agent voice recording and/or navigation input. The trainer can also add and save coaching notes. Coaching notes can be exported to Excel.

In FIG. 16, the agent “Bessie Radd” and scenario 1 are selected in the user identification panel 1602. Statistics for scenario 1 are shown in the step information 1604 panel. Other agents in class CCNH14 (selected in navigation interface 1608) can be selected for review in user listing panel 1606.

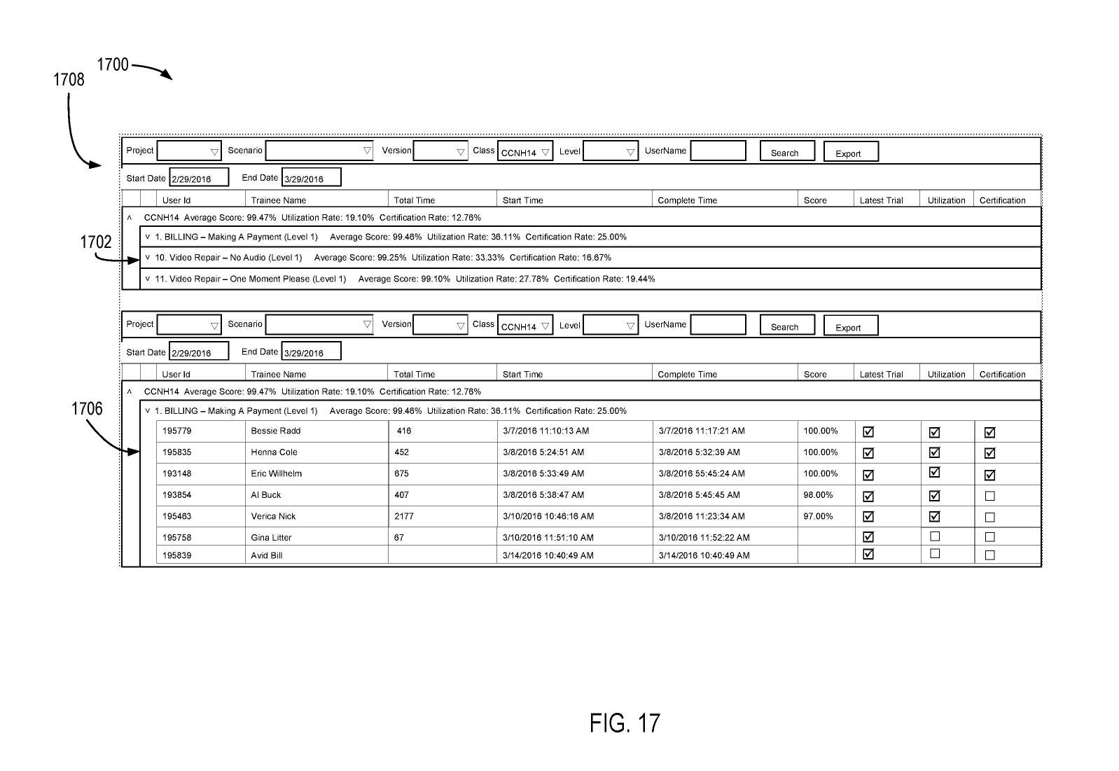

FIG. 17 is an example of a readiness report interface 1700. The readiness report interface can include a scenario summary section 1702, a scenario detail section 1706 and a navigation interface 1708. The scenario summary information can include summary statistics of scenarios. The scenario detail section 1706 can include statistics for individual agent performance in the scenario, including user id, trainee name, start time, complete time, score percentage, an indicator of passing a latest trial, an indicator of meeting a utilization and an indicator of certification of knowledge of the scenario. The navigation interface 1708 can include selections for projects, scenarios, versions, class selection, level and/or dates.

The readiness report can include information used in evaluating whether an agent and/or class is making expected progression in the training. Statistics for an agent and/or class can include average score, utilization rate and certification rate. In the embodiment shown, an average score is used to identify which scenarios require further review based on class and/or agent scores. In the embodiment shown, a utilization rate is used to check if a trainer is moving the class through the training on time based on a New Hire agenda schedule. A utilization report can show when an agent completed the simulation and the number of agents that have completed the simulation. In the embodiment shown, a certification rate is a number of agents with a 100% score, representing a mastery of a scenario.

In FIG. 17, a class of CCNH14 is selected. The class has attempted scenarios 1, 10 and 11 as seen in the scenario summary section 1702. Currently, the scenario 1 is under review and individual statistics are being shown for agents of the class of CCNH14 in scenario detail section 1706.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell®, Microsoft®, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Various techniques, or certain aspects or portions thereof, may take the form of program code (i.e., instructions) embodied in tangible media, such as floppy diskettes, CD-ROMs, hard drives, magnetic or optical cards, solid-state memory devices, a nontransitory computer-readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and nonvolatile memory and/or storage elements), at least one input device, and at least one output device. The volatile and nonvolatile memory and/or storage elements may be a RAM, an EPROM, a flash drive, an optical drive, a magnetic hard drive, or other medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Each computer system includes one or more processors and/or memory; computer systems may also include various input devices and/or output devices. The processor may include a general purpose device, such as an Intel®, AMD®, or other “off-the-shelf” microprocessor. The processor may include a special purpose processing device, such as ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, or magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, or off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of materials, frequencies, sizes, lengths, widths, shapes, etc., to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. A system for simulating a call center comprising:
a user interface for presenting a call center scenario, the user interface comprising:
a training interface for presenting a series of screens that represent a call center software interface and receiving agent input, each screen comprising at least one agent input element; and
a simulation interface for presenting pre-recorded audio and receiving agent audio, the pre-recorded audio providing a simulated customer response for a current screen provided by the training interface;
a grading system configured to receive the agent input from the training interface, determine an intermediate grade for a set of agent inputs based at least in part on grading criteria, and determine a scenario grade based at least in part on one or more intermediate grades; and
a reporting system configured to provide access to the scenario grade, one or more intermediate grades, agent input and agent audio.

2. The system of claim 1, further comprising a quiz interface for presenting a quiz, the quiz interface comprising an explanation pane and an answer input, the answer input configured to receive a set of answer selections from an agent,
wherein the grading system is further configured to grade the set of answer selections based at least in part on quiz grading criteria, and
wherein the reporting system is further configured to provide access to the quiz grade.

3. The system of claim 2, wherein the reporting system is further configured to provide access to a combination of the quiz grade and the scenario grade.

4. The system of claim 2, wherein the reporting system is further configured to provide access to a set of statistics that combine a set of quiz grades and a set of scenario grades.

5. The system of claim 1, further comprising storage for storing the screens, agent input, pre-recorded audio, agent audio, one or more intermediate grades and scenario grade.

6. The system of claim 1, further comprising a simulation design interface comprising:
a screen editor for defining a screen background and agent inputs;
an audio-file receiver for associating the pre-recorded audio with a screen; and
a script editor for defining a series of screens and grading criteria.

7. The system of claim 1, wherein the reporting system is configured to provide access to a plurality of scenario grades for a plurality of agents.

8. The system of claim 7, wherein the reporting system further comprises an access restriction system that provides access to grading criteria based on authentication information.

9. The system of claim 8, wherein the access restriction system is configured to:
provide access to the scenario grade and the one or more intermediate grades associated with an agent to the agent; and
provide access to the plurality of scenario grades and the one or more intermediate grades for agents managed by a manager to the manager.

10. A method for simulating a call center comprising:
presenting a user interface with a training interface part and a simulation interface part;
playing pre-recorded audio simulating a client portion of a conversation through the training interface;
receiving live audio from a user responding to the pre-recorded audio through the training interface;
receiving user input into the simulation interface; and
grading a simulation based on grading criteria and the user input into the simulation interface.

11. The method of claim 10, further comprising:
presenting a quiz, the quiz comprising an explanation pane and an answer input for a set of questions;
receiving a set of answer selections corresponding to the set of questions;
grading the set of answer selections based at least in part on quiz grading criteria;
determining a quiz grade based at least in part on the grading; and
providing access to the quiz grade.

12. The system of claim 11, further comprising providing access to a combination of the quiz grade and the scenario grade.

13. The system of claim 11, further comprising providing access to a set of statistics that combine a set of quiz grades and a set of scenario grades.

14. The method of claim 10, wherein grading the simulation further comprises grading the simulation based on the user input into the simulation interface, the live audio and the grading criteria.

15. The method of claim 10, further comprising receiving a play audio event through the training interface to cause the playing of pre-recorded audio simulating a client portion of a conversation.

16. The method of claim 10, wherein receiving user input into the simulation interface includes simulating a client call center interface.

17. At least one computer readable storage medium having stored thereon instructions that, when executed by a computing device, cause the computing device to:
render a set of screens, the screens representing a scenario including an incoming call simulation and a call-center software simulation, the scenario divided into a set of operations which can include one or more screens;
for at least a subset of the screens:
play pre-recorded audio simulating a client portion of a conversation;
receive user audio from a user responding to the pre-recorded audio;
receive user input into a simulation interface for at least a subset of the set of operations; and
grade the user input based at least in part on grading criteria defined for the subset of operations;
grade the incoming call simulation based on a set of grades for the set of operations.

18. The computer readable storage medium of claim 17, further comprising converting the user audio to text and grading the user audio based at least in part on the grading criteria defined for the screen.

19. The computer readable storage medium of claim 17, wherein to grade the user input based at least in part on grading criteria further includes to grade the incoming call simulation based on a match between the pre-recorded audio with the user input into the simulation interface and the user audio.

20. The computer readable storage medium of claim 17, wherein to grade the user input based at least in part on grading criteria further includes to grade the incoming call simulation based on a match between expected responses to the pre-recorded audio and the user input into the incoming call simulation interface.
